(19) United States
(12) Patent Application Publication
(10) Pub. No.: US 2020/0070815 A1
(43) Pub. Date: Mar. 5, 2020

(54) AUTONOMOUS DRIVING METHOD AND APPARATUS OF VEHICLE, PROGRAM AND RECORDING MEDIUM

(71) Applicants: HYUNDAI MOTOR COMPANY, Seoul (KR); KIA MOTORS CORPORATION, Seoul (KR)

(72) Inventor: Hyuk KO, Incheon (KR)

(21) Appl. No.: 16/193,449

(22) Filed: Nov. 16, 2018

(30) Foreign Application Priority Data
Aug. 31, 2018 (KR) 10-2018-0103504

(51) Int. Cl. B60W 30/06; G08G 1/14; B62D 15/02; G08G 1/0968; G05D 1/02

(52) U.S. Cl. CPC B60W 30/06; G08G 1/143; G05D 1/0276; G08G 1/148; G08G 1/0968; B62D 15/0285

(57) ABSTRACT

An autonomous driving method of a vehicle includes: starting, by a controller, a parking mode of the vehicle; receiving, by the controller, at least one of a control signal of a parking lot and signals of parked vehicles in the parking lot; and controlling, by the controller, the vehicle to be parked according to the control signal of the parking lot when only the control signal of the parking lot is received.

### CROSS-REFERENCE TO RELATED APPLICATION

This application claims the benefit of Korean Patent Application No. 10-2018-0103504, filed on Aug. 31, 2018, which is hereby incorporated by reference as if fully set forth herein.

### TECHNICAL FIELD

The present disclosure relates to an autonomous driving method and apparatus of a vehicle, and a program and recording medium therefor, and more particularly, to an autonomous driving method and an apparatus of a vehicle capable of searching for a suitable parking area through a control signal of a parking lot and signals of other vehicles parked in the parking lot, and a program and recording medium therefor.

### BACKGROUND

An autonomous vehicle refers a vehicle which recognizes a surrounding environment thereof, determines a driving situation, and autonomously travels to a given destination, without driver intervention.

In particular, there are apparatuses and methods of performing parking guidance and autonomously driving and parking a vehicle using vehicle-to-infrastructure (V2I) communication between a vehicle and the infrastructure of a parking lot.

However, a control system of the parking lot provides current vehicle parking information to a vehicle when the vehicle enters the parking lot. In a large parking lot, other vehicles may additionally leave the parking lot even after the vehicle enters the parking lot. Accordingly, the vehicle may not receive information on a parking area in real time.

### SUMMARY

The present disclosure is directed to an autonomous driving method and apparatus of a vehicle, and a program and recording medium therefor that substantially obviate one or more problems due to limitations and disadvantages of the related art.

An object of the present disclosure is to solve the problem of parking guidance by vehicle-to-infrastructure (V2I) communication and to receive parking guidance even when V2I communication fails.

The technical problems solved by the present disclosure are not limited to the above technical problems and other technical problems which are not described herein will become apparent to those skilled in the art from the following description.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

According to an exemplary embodiment of the present disclosure, an autonomous driving method of a vehicle includes: starting, by a controller, a parking mode of the vehicle; receiving, by the controller, at least one of a control signal of a parking lot and signals of one or more parked vehicles in the parking lot; and controlling, by the controller, the vehicle to be parked according to the control signal of the parking lot when only the control signal of the parking lot is received.

The parking the vehicle according to the control signal of the parking lot may include displaying an unoccupied parking area of the parking lot on an audio video navigation (AVN) system of the vehicle and guiding the vehicle to be parked in the unoccupied parking area of the parking lot.

When only the signals of other parked vehicles in the parking lot are received and signals of a plurality of other parked vehicles are received, a signal of a moving vehicle among the signals of the parked vehicles may be searched for and the vehicle may be guided to be parked in a parking area where the moving vehicle has been parked.

The signal of the moving vehicle may be searched for by receiving at least one of a startup signal, a brake signal, a steering signal and an accessary signal of the moving vehicle.

When the signals of the plurality of moving vehicles among the signals of the parked vehicles may be searched for, the vehicle is guided to be parked in a nearest parking area.

The autonomous driving method may further include determining whether the nearest parking area is a parking restricted area.

When the control signal of the parking lot and the signals of other parked vehicles in the parking lot are simultaneously received, the vehicle may be guided to be parked in a nearest paring area between the control signal of the parking lot and the signals of other parked vehicles in the parking area.

When the nearest parking area is based on the control signal of the parking lot, the parking the vehicle according to the control signal of the parking lot may include displaying an unoccupied parking area of the parking lot on an audio video navigation (AVN) system of the vehicle and guiding the vehicle to be parked in the unoccupied parking area of the parking lot.

When the nearest parking area is based on the signals of other parked vehicles in the parking lot, a signal of a moving vehicle among the signals of parked vehicles may be searched for and the vehicle may be guided to be parked in a parking area where the moving vehicle has been parked.

The signal of the moving vehicle may be searched for by receiving at least one of a startup signal, a brake signal, a steering signal and an accessary signal of the moving vehicle.

The autonomous driving method may further include determining whether the nearest parking area is a parking restricted area.

According to another exemplary embodiment of the present disclosure, an autonomous driving apparatus of a vehicle includes: a wireless communication device connected to communication devices of a parking lot server and one or more parked vehicles through wireless communication when the vehicle enters a parking lot; a controller configured to control autonomous driving of the vehicle to a parking area to be parked based on a control signal of the parking lot server and parking information of the one or more parked vehicles; and a vehicle driving controller configured to control an actuator of the vehicle under control of the controller. The control signal of the parking lot server includes parking lot map data and state information of each parking area in the parking lot.

The controller may guide the vehicle to be parked in a nearest parking area when there is a plurality of pieces of parking information provided by the other parking vehicles.

The control signal of the parking lot server may include information related to a parking restricted area of each parking area in the parking lot.

The autonomous driving apparatus may further include a memory configured to store the information related to the parking restricted area of each parking area in the parking lot received from the control signal of the parking lot server, and the controller may guide the vehicle to be parked in a second nearest parking area when a nearest parking area is the parking restricted area.

According to another aspect of the present disclosure, a program recorded on a computer-readable recording medium is configured to execute the above-described autonomous driving method of the vehicle by a processor.

According to another aspect of the present disclosure, there is provided a computer-readable recoding medium having recorded thereon the above-described program.

The aspects of the present disclosure are only a part of the preferred embodiments of the present disclosure, and various embodiments based on technical features of the present disclosure may be devised and understood by a person having ordinary skill in the art based on the detailed description of the present disclosure.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a diagram illustrating an autonomous driving system in a parking lot according to an embodiment of the present disclosure;

FIG. 2 is a diagram illustrating a parking lot server according to an embodiment of the present disclosure;

FIG. 3 is a diagram illustrating an autonomous driving apparatus of a vehicle according to an embodiment of the present disclosure; and

FIG. 4 is a diagram illustrating an autonomous driving method of a vehicle according to an embodiment of the present disclosure.

### DETAILED DESCRIPTION

Hereinafter, methods and vehicle controllers, to which the embodiments of the present disclosure are applied, will be described in detail with reference to the accompanying drawings. The terms used in the following embodiments are used only to illustrate specific examples and are not limited thereto.

The terms “comprise”, “include”, “be placed” or “be composed of” disclosed in the following embodiments should be interpreted not to exclude other elements but to further include such other elements since the corresponding elements may be inherent unless mentioned otherwise.

As used in the detailed description and claims, the singular forms are intended to include the plural forms as well, unless the context clearly indicates otherwise. The term “or/and” should be interpreted to include any and all possible combinations of one or more of listed items.

The autonomous driving method and apparatus of the vehicle according to the embodiments are not limited to automobiles and may be used in moving means, which move at a predetermined speed, other than automobiles, such as a motorcycle or an airplane in a hangar.

FIG. 1 is a diagram illustrating an autonomous driving system in a parking lot according to an embodiment of the present disclosure.

An autonomous driving system according to the present embodiment may include an autonomous driving apparatus 100 provided in a vehicle entering a parking lot, other parked vehicles 200 for generating parking signals in the parking lot and a parking lot server 300 for generating a control signal of the parking lot. Here, the control signal of the parking lot server may include information related to a parking restricted area of each parking area in the parking lot. Here, the information related to the parking restricted area may include a handicapped parking area, a lightweight vehicle parking area, or an expectant mother parking area.

The autonomous driving apparatus 100 may transmit and receive data to and from the other parked vehicles 200 and the parking lot server 300 through wireless communication.

The parking lot server 300 may transmit and receive data to and from the autonomous driving apparatus 100 and the other parked vehicles 200 directly or over a network

The parking lot server 300 senses a vehicle including the autonomous driving apparatus 100, which enters the parking lot, and provides parking lot information to the autonomous driving apparatus 100 of the vehicle entering the parking lot. The parking lot information may include parking lot map data, a parkable space (unoccupied parking area) and a driving route to a parking area. The parking lot map data may be a map, to which a virtual lane for autonomous driving of a vehicle is applied.

The autonomous driving apparatus 100 controls autonomous driving of the vehicle to a parking space where the vehicle will be parked based on the parking lot information provided by the parking lot server 300 when the vehicle enters the parking lot. The autonomous driving apparatus 100 may travel using the virtual lane in the parking lot map data included in the parking lot information.

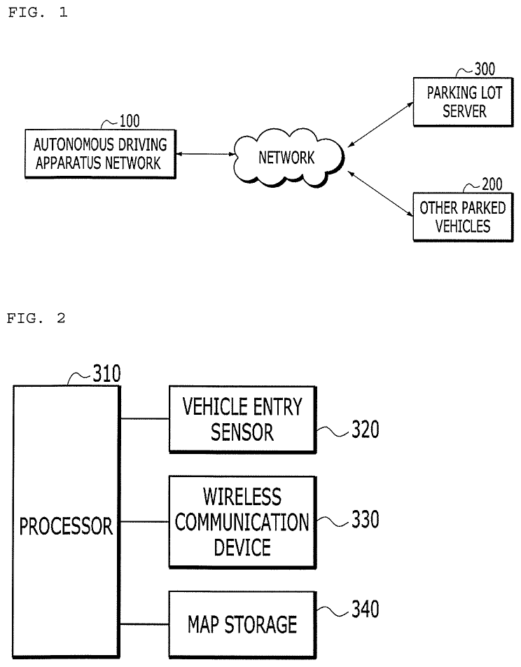

FIG. 2 is a diagram illustrating a parking lot server according to an embodiment of the present disclosure.

As shown in the figure, the parking lot server 300 may include a vehicle entry sensor 320, a wireless communication device 330, a map storage 340 and a processor 310.

The vehicle entry sensor 320 is mounted at the entrance of the parking lot and senses a vehicle entering the parking lot. The vehicle entry sensor 320 may include one or more of sensors such as radar, laser, ultrasound and image sensors.

The wireless communication device 330 performs wireless communication with the autonomous driving apparatus 100 provided in the vehicle. The wireless communication device 330 may use any one of wireless Internet, local area communication and mobile communication, and the autonomous driving apparatus may be connected to the communication devices of the parking lot server 300 and the other parked vehicles 200 through wireless communication to receive parking information provided by the parking lot server 300 and the other parked vehicles 200.

The map storage 340 may store parking lot map data.

The processor 310 senses the vehicle entering the parking lot through the vehicle entry sensor 320 and transmits the parking lot map data stored in the map storage 340 to the vehicle through the wireless communication device 330.

The processor 310 manages information on parking spaces in the parking lot. The processor 310 collects state information (unoccupied, parked, constructed, etc.) of the parking space through a sensor installed in each parking space. In addition, the processor 310 manages the number and positions of parking spaces where a vehicle may park.

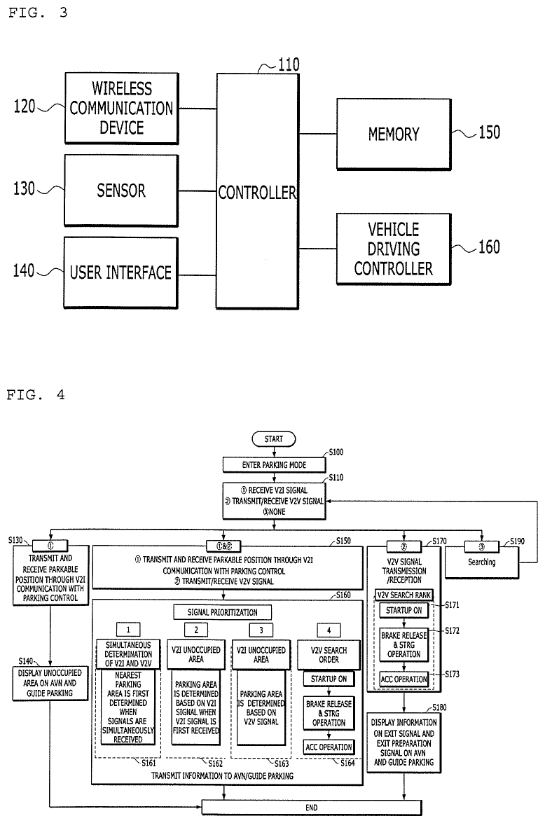

FIG. 3 is a diagram illustrating an autonomous driving apparatus of a vehicle according to an embodiment of the present disclosure.

As shown in the figure, the autonomous driving apparatus 100 includes a wireless communication device 120, a sensor 130, a user interface 140, a memory 150, a vehicle driving controller 160, and a controller 110.

The wireless communication device 120 performs wireless communication with the parking lot server 300. The wireless communication device 120 uses wireless Internet, local area communication and mobile communication.

The sensor 130 senses an obstacle and measures the position of the vehicle. The sensor 130 includes a radar, laser, ultrasound or image sensor, a global positioning system (GPS) reception module, etc.

The user interface 140 receives data and a control command from a user and is implemented as any one of input means such as a keypad and a touchscreen.

The memory 150 stores data generated according to various programs and operations required to control autonomous driving of the autonomous driving apparatus 100 and stores the parking lot information received through the wireless communication device 120.

The vehicle driving controller 160 controls the actuator of the vehicle to perform any one of deceleration, acceleration, braking and shifting of the vehicle. The vehicle driving controller 160 includes a steering controller, a brake controller, an acceleration controller, a gear controller, etc. In the present disclosure, the vehicle driving controller 160 may be another electronic control unit (ECU) in the vehicle or embedded in the controller 110 as one unit.

The controller 110 may be an electronic control unit (ECU) to control overall operation of the autonomous driving apparatus 100 and control the vehicle driving controller 160 based on the parking lot information received from the parking lot server 300 to perform autonomous driving. The controller 110 may perform communication with the parking lot server 300 through the wireless communication device 120 when the vehicle enters the parking lot, and perform control such that the vehicle is parked in the nearest parking area, when there is a plurality of pieces of parking information provided by the other parking vehicles.

In addition, the controller 110 may display the parking lot map data received from the parking lot server 300 on a display. Here, the controller 110 maps the state information of each parking space to the parking lot map data and displays the result of mapping. In addition, the controller 110 selects any one of the parking spaces displayed on the display based on data received from the user interface 140.

FIG. 4 is a diagram illustrating an autonomous driving method of a vehicle according to an embodiment of the present disclosure. Hereinafter, the autonomous driving method of the vehicle according to the embodiment of the present disclosure will be described.

First, the vehicle enters a parking mode (S100). In this case, the vehicle may enter the parking lot.

The vehicle may receive at least one of the control signal (V2I signal) of the parking lot and the signals (V2V signals) of the other parked vehicles in the parking lot through the wireless network (S110).

At this time, only control signal 1 of the parking lot may be received, only signals 2 of the other parked vehicles in the parking lot may be received, both control signal 1 and signals 2 may be received, or no signal may be received.

When only control signal 1 of the parking lot is received, the vehicle may be parked according to the control signal of the parking lot (S130).

Here, the unoccupied parking area of the parking lot may be displayed on the AVN of the vehicle using the information received from the control signal of the parking lot and the vehicle may be guided to the unoccupied parking area of the parking lot (S140).

When control signal 1 of the parking lot and signals 2 of the other parked vehicles in the parking lot are both received (S150), the vehicle may be parked using the control signal (V2I signal) of the parking lot and the signals (V2V signals) of the other parked vehicles.

At this time, the above-described signals may be prioritized (S160). Specifically, when the control signal of the parking lot and the signals of other parked vehicles in the parking lot are simultaneously received, the vehicle may be guided to the nearest parking area (S161).

At this time, if the nearest parking area is based on the control signal of the parking lot, the unoccupied parking area of the parking lot may be displayed on the AVN of the vehicle using the information received from the control signal of the parking lot and the vehicle may be guided to be parked in the unoccupied parking area of the parking lot.

When control signal 1 of the parking lot is first received (S162), the vehicle may be guided to be parked according to the control signal. Since signal 2 of the other parked vehicle is subsequently received, when the vehicle cannot be parked according to control signal 1 of the parking lot, the vehicle may be parked according to signal 2 of the parked vehicle (S163). The case where the vehicle cannot be parked according to the control signal of the parking lot may include the case where the parking area provided by control signal 1 of the parking lot may be a parking area where parking is impossible under the current law, such as a handicapped parking area, a lightweight parking area or a female-only parking area.

When the nearest parking area is based on signal 2 of the other parked vehicle in the parking lot, for example, when the signals of a plurality of other parked vehicles are received, the signal of a moving vehicle, that is, a vehicle preparing to exit, among the parked vehicles may be searched for and the vehicle may be guided to be parked in the corresponding parking area.

At this time, whether the other parked vehicle moves may be determined depending on whether the signal received from the vehicle includes a startup on signal, a brake signal, a steering movement signal or an accessary on signal (S164).

When only the signals V2V of the other parked vehicles in the parking area are received and the signals of a plurality of other parked vehicles are received (S170), the signal of the moving vehicle among the signals of the parked vehicles may be searched for and the vehicle may be guided to be parked in a parking area where the moving vehicle has been parked.

At this time, determination as to whether the other parked vehicle moves may be made using the same method as step S164 (S171 to S173). That is, information on a vehicle for transmitting an exit signal or a vehicle for transmitting an exit preparation signal, that is, information on the parking area, may be displayed on the audio video navigation (AVN) system of the vehicle and the vehicle may be guided to be parked in the corresponding parking area (S180).

When only control signal 1 of the parking lot is received and when all signals 2 of the other parked vehicles in the parking lot are not received (3), only the control signal of the parking lot may be received again and signals 2 of the other parked vehicles in the parking lot may be searched for.

In the autonomous driving method and apparatus of the vehicle, since the vehicle can rapidly and accurately search for a parkable area using V2V communication in addition to V2I communication when entering the parking lot, the vehicle can be guided to be parked even when V2I communication cannot be performed.

The autonomous driving method of the vehicle is recorded in a computer-readable recording medium as a program in which the autonomous driving method of the vehicle is implemented by a processor.

In an autonomous driving method and apparatus of a vehicle, and a program and recording medium therefor according to the embodiments, since the vehicle can rapidly and accurately search for a parkable area using V2V communication in addition to V2I communication when entering the parking lot, the vehicle can be guided to be parked even when V2I communication cannot be performed.

Those skilled in the art will appreciate that the present disclosure may be carried out in other specific ways than those set forth herein without departing from the spirit and essential characteristics of the present disclosure.

The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

What is claimed is:

1. An autonomous driving method of a vehicle, the method comprising steps of:
starting, by a controller, a parking mode of the vehicle;
receiving at least one of a control signal of a parking lot generated by a parking lot server and signals of one or more parked vehicles in the parking lot; and
controlling, by the controller, the vehicle to be parked according to the control signal of the parking lot when only the control signal of the parking lot is received.

2. The autonomous driving method of claim 1, wherein the step of controlling the vehicle to park includes:
displaying an unoccupied parking area of the parking lot on an audio video navigation (AVN) system of the vehicle; and
guiding the vehicle to be parked in the unoccupied parking area of the parking lot.

3. The autonomous driving method of claim 1, wherein, when only the signals of the one or more parked vehicles in the parking lot are received, a signal of a moving vehicle among the signals of the one or more parked vehicles is searched for and the vehicle is guided to a parking area from which the moving vehicle is preparing to leave.

4. The autonomous driving method of claim 3, wherein the signal of the moving vehicle is searched for by receiving at least one of a startup signal, a brake signal, a steering signal, and an accessary signal of the moving vehicle.

5. The autonomous driving method of claim 3, wherein, when the signal of the moving vehicle is being searched for, the vehicle is guided to be parked in a nearest parking area.

6. The autonomous driving method of claim 5, further comprising determining whether the nearest parking area is a parking restricted area.

7. The autonomous driving method of claim 1, wherein, when the control signal of the parking lot and the signals of the one or more parked vehicles in the parking lot are simultaneously received, the vehicle is guided to a nearest parking area by comparing the control signal of the parking lot and the signals of the one or more parked vehicles in the parking area.

8. The autonomous driving method of claim 7, wherein, when the nearest parking area is based on the control signal of the parking lot, an unoccupied parking area of the parking lot is displayed on an audio video navigation (AVN) system of the vehicle and the vehicle is guided to be parked in the unoccupied parking area of the parking lot.

9. The autonomous driving method of claim 7, wherein, when the nearest parking area is based on the signals of the one or more parked vehicles in the parking lot, a signal of a moving vehicle among the signals of the one or more parked vehicles is searched for and the vehicle is guided to be parked in a parking area from which the moving vehicle is preparing to leave.

10. The autonomous driving method of claim 9, wherein the signal of the moving vehicle is searched for by receiving at least one of a startup signal, a brake signal, a steering signal, and an accessary signal of the moving vehicle.

11. The autonomous driving method of claim 9, further comprising determining whether the nearest parking area is a parking restricted area.

12. An autonomous driving apparatus of a vehicle, the apparatus comprising:
a wireless communication device connected to communication devices of a parking lot server and one or more parked vehicles through wireless communication when the vehicle enters a parking lot;
a controller configured to control autonomous driving of the vehicle to a parking area based on a control signal of the parking lot server and parking information of the one or more parked vehicles; and
a vehicle driving controller configured to control an actuator of the vehicle under control of the controller,
wherein the control signal of the parking lot server includes parking lot map data and state information of each parking area in the parking lot.

13. The autonomous driving apparatus of claim 12, wherein the controller guides the vehicle to be parked in a first nearest parking area when parking information is received by a plurality of parking vehicles.

14. The autonomous driving apparatus of claim 13, wherein the control signal of the parking lot server includes information related to a parking restricted area of each parking area in the parking lot.

15. The autonomous driving apparatus of claim 14, further comprising a memory configured to store the information related to the parking restricted area of each parking area in the parking lot received from the control signal of the parking lot server,
wherein the controller guides the vehicle to be parked in a second nearest parking area when the first nearest parking area is the parking restricted area.

16. A program recorded on a computer-readable recording medium configured to execute the autonomous driving method of claim 1 by a processor.

17. A computer-readable recoding medium having recorded thereon the program according to claim 16.
